(19) United States
(12) Patent Application Publication
(10) Pub. No.: US 2026/0127927 A1
(43) Pub. Date: May 7, 2026

(54) SYSTEMS AND METHODS FOR VERIFIABLE CREDENTIALS FOR PHYSICAL ACCESS CONTROL

(71) Applicant: Allthenticate, Inc., Houston, TX (US)

(72) Inventors: Gaurav Shashikumar KHOT, Houston, TX (US); Chad Samuel SPENSKY, Houston, TX (US)

(73) Assignee: Allthenticate, Inc., Houston, TX (US)

(21) Appl. No.: 19/383,293

(22) Filed: Nov. 7, 2025

Related U.S. Application Data
(60) Provisional application No. 63/717,451, filed on Nov. 7, 2024.

(51) Int. Cl. G07C 9/22; G07C 9/00; G07C 9/27

(52) U.S. Cl. CPC G07C 9/22; G07C 9/00309; G07C 9/00571; G07C 9/27; G07C 2009/00388; G07C 2009/00793

(57) ABSTRACT

A system and method for decentralized physical access control improves security and resilience over conventional centralized systems. The system includes a user device storing a verifiable credential (VC) cryptographically signed by an issuer. To request access, the user device generates a verifiable presentation (VP) containing the VC and a new, single-use proof-of-possession signature. A door access control device receives the VP and performs a local verification of both the issuer's signature on the VC and the user's proof-of-possession signature on the VP. This verification is performed without requiring a real-time connection to a central server. Upon successful local verification, the door access control device actuates an electronic lock to grant access. This decentralized process enables secure offline operation and prevents the use of copied credentials, overcoming the single-point-of-failure and connectivity limitations of prior art.

### CROSS REFERENCE TO RELATED APPLICATION

This application claims priority to and the benefit of U.S. Provisional Patent Application No. 63/717,451, filed on Nov. 7, 2024. The foregoing provisional application is incorporated by reference herein in its entirety.

### GENERAL DESCRIPTION

Conventional physical access control systems have historically relied on centralized architectures, which present significant limitations. In these models, access decisions are managed by a central server that communicates with peripheral devices like card readers or electronic locks. This dependency creates a single point of failure; if the central server or the network connecting to it becomes unavailable, the entire system can cease to function, potentially locking individuals in or out of secure areas. Furthermore, these systems require constant connectivity, making them unsuitable for remote locations or environments with unreliable network infrastructure. The management of physical tokens such as key cards or fobs also introduces substantial administrative overhead and security risks. Issuing, tracking, and revoking these tokens is a manually intensive process, and lost or stolen credentials pose a significant security threat until they are deactivated in the central database.

To address these challenges, verifiable credentials (VCs) are utilized to make decentralized decisions independent of a central control center, representing a significant technological improvement. In some implementations, credentials are built and distributed by issuers and are composed of several key components. These include identifiers for issuers, holders, and subjects, which are used to retrieve cryptographic information linked to the entities they identify. While the holder and Subject are the same entity in many cases, they may be distinct; for instance, the subject of an assertion could be a dog, while the holder of the VC is the dog's owner. The credential also contains assertions made by the issuer that communicate the information it has about the subject. Furthermore, cryptographic signatures are employed to verify that the identified entity has created the assertions and to bind the holder to the credential using key material. By embedding verifiable, cryptographically secure claims into a digital credential, this approach eliminates the vulnerabilities of physical tokens and the reliance on a constantly online central server.

Holders of VCs present the credential to a verifier to receive services based on the presented data. This model allows for offline verification, as the access control device itself can cryptographically validate the credential without needing to query a central database. For example, a university acting as an issuer may issue a graduate degree in the form of a VC to a student, who is both the holder and the subject. The student can then present this VC to a potential employer, the verifier, to prove their educational qualifications for a job. The employer may then provide the service of employment based on the successful verification of the data within the graduate degree VC, among other factors. Similarly, in a physical access scenario, an employee's mobile device (holder) can present a VC to a smart lock (verifier), which grants access based on its intrinsic ability to verify the credential, thereby providing a more resilient, secure, and efficient solution than prior art.

### SUMMARY

The embodiments disclosed herein relate to systems and methods that improve the security and resilience of physical access control. Embodiments include an issuing authority (e.g., an Identity and Access Management control center) configured to generate a primary digital credential (e.g., a verifiable credential) and embed a plurality of secondary contextual data tracks (e.g., cryptographically signed assertions of access rights or employment status) for one or more users, referred to as holders. The system generates a distinct, portable digital credential, which is managed within a decentralized trust framework using a novel cryptographic binding structure between the issuer, the holder's device, and the credential itself. This structure provides a technical advantage by significantly improving the resilience of the system by enabling offline verification, thus removing the single point of failure and constant connectivity requirements inherent in traditional, centralized access control databases. The system associates each issued credential with the correct holder and executes a secure verification protocol when the credential is presented to a verifier (e.g., an electronic door lock). The system provides the results of this verification, such as an access grant or denial, to the user via the access control device. The system is also capable of managing access for designated holders to a variety of physical resources, thereby improving the functioning of the computer itself by enabling more secure, efficient, and resilient management of physical spaces.

In one embodiment, a physical access control system is disclosed. The system comprises a user device having a first processor, a first memory, and a first wireless transceiver, where the first memory stores a verifiable credential (VC). The VC is digitally signed by an issuer from a control center and contains one or more assertions related to physical access. The system also includes a door access control device having a second processor, a second memory, a second wireless transceiver, and an electronically controlled lock mechanism. The first processor of the user device is configured to generate a verifiable presentation (VP) comprising the VC and a proof-of-possession signature, the proof-of-possession signature being generated by the user device in response to an access request, and to transmit the VP via the first wireless transceiver. The second processor of the door access control device is configured to receive the VP from the user device via the second wireless transceiver; locally verify both the issuer's digital signature on the VC and the user device's proof-of-possession signature on the VP, wherein the local verification is executed, outside of the control center, using data stored in the second memory and data received in the VP; and actuate the electronically controlled lock mechanism to grant access based on a successful local verification of both signatures.

In another embodiment, a method for decentralized physical access control is disclosed. The method for decentralized physical access control comprises receiving, by a processor of a door access control device from a user device, a verifiable presentation. The VP comprises a verifiable credential digitally signed by an issuer from a control center and containing one or more assertions, and a proof-of-possession signature generated by the user device. The method continues by locally verifying outside of the control center, by the processor of the door access control device, the integrity and authenticity of the VP, wherein locally verifying includes validating the issuer's digital signature on the VC and validating the user device's proof-of-possession signature on the VP. Finally, the method involves actuating, by the door access control device, a physical lock mechanism to an unlocked state in response to the successful validation of both the issuer's digital signature and the proof-of-possession signature.

In another embodiment, a door access control device is disclosed. The door access control device for a decentralized physical access control system comprises a processor, a wireless transceiver, an electronically controlled lock mechanism, and a memory storing instructions. When executed by the processor, these instructions cause the door access control device to receive, via the wireless transceiver from a user device, a verifiable presentation, the VP including a verifiable credential signed by an issuer from a control center and a proof-of-possession signature generated by the user device. The device will then locally verify, without communication to the control center, both the issuer's digital signature on the VC and the user device's proof-of-possession signature on the VP, and actuate the electronically controlled lock mechanism to grant access based on a successful local verification of both signatures.

### BRIEF DESCRIPTION OF THE DRAWINGS

FIG. 1 is a block diagram illustrating an exemplary system architecture for physical access control using verifiable credentials, according to an embodiment.

FIG. 2A is a sequence diagram illustrating an exemplary method for account creation, wallet pairing, and the granting of access via the issuance of a verifiable credential.

FIG. 2B is a sequence diagram illustrating an exemplary method for user interaction with an access control point, including successful access with a valid credential, the administrative revocation of a credential, and a failed access attempt with a revoked credential.

### DETAILED DESCRIPTION

The particulars shown herein are by way of example and for purposes of illustrative discussion of the disclosed embodiments and are presented to provide a readily understood description of the principles and conceptual aspects. In this regard, no attempt is made to show structural details in more detail than is necessary for a fundamental understanding, and the description taken together with the drawings make apparent to those skilled in the art how the disclosed devices and methods may be embodied in practice.

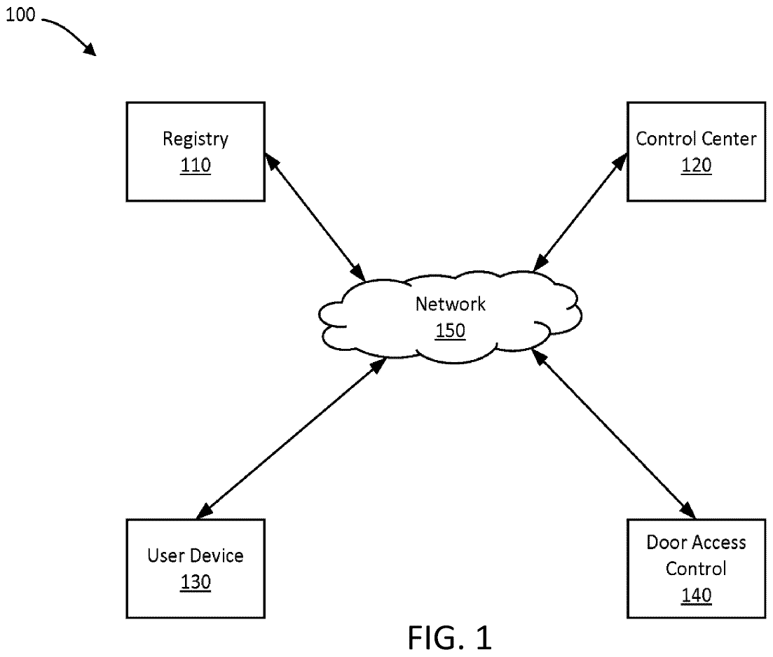

As seen in FIG. 1, a system 100 can include a registry 110, a control center 120, a user device 130, and a door access control 140. The user device 130 comprises at least a first processor, a first memory, and a first wireless transceiver. The door access control 140 comprises at least a second processor, a second memory, and a second wireless transceiver. The door access control 140 further includes an electronically controlled lock mechanism. The second processor is configured to actuate the electronically controlled lock mechanism, for example by generating a control signal to transition the lock mechanism from a locked to an unlocked state, based on successful verification. While shown as single devices, in some implementations, the registry 110, the control center 120, the user device 130, and/or the door access control 140 may be a collection of devices (e.g., a data center). One or more of the registry 110, the control center 120, the user device 130, and/or the door access control 140 can include a processor and/or a memory (not shown in FIG. 1). The processor of the registry 110, the control center 120, the user device 130, and/or the door access control 140 may be any suitable processing device configured to execute the functions described herein as being executed at that device. For example, the processor may be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a Digital Signal Processor (DSP), a programmable logic controller (PLC) and/or the like. The processor may be, for example, a hardware based integrated circuit (IC), or any other suitable processing device configured to run and/or execute a set of instructions or code. The processor may be operatively coupled to a memory, e.g., through a system bus (for example, address bus, data bus and/or control bus).

The memory of the registry 110, control center 120, user device 130, and/or door access control 140 may be, for example, a random-access memory (RAM), a memory buffer, a hard drive, a flash memory, a read-only memory (ROM), an erasable programmable read-only memory (EPROM), and/or the like. In some instances, the memory can store, for example, one or more software programs and/or code that can include instructions to cause the processor to perform one or more processes, functions, and/or the like. In some implementations, the memory may be a portable memory (for example, a flash drive, a portable hard disk, and/or the like) that may be operatively coupled to the processor. In some instances, the memory may be operatively coupled to another device. For example, in some embodiments, the memory may be coupled to a remote server or database, e.g., for sending and/or receiving information therefrom. In some embodiments, the memory and processor may be implemented on a single chip. In other embodiments, the memory and processor may be implemented on separate chips.

In some embodiments, the registry 110, control center 120, user device 130, and door access control 140 may be communicably coupled via a network 150. The network 150 may be any type of network implemented as a wired network and/or wireless network and used to operatively couple the registry 110, the control center 120, the user device 130, and/or door access control 140. The communication may or may not be encrypted. A wireless network may refer to any type of digital network that is not connected by cables of any kind. Examples of wireless communication in a wireless network include, but are not limited to cellular, near-field communication, radio, satellite, and microwave communication. However, a wireless network may connect to a wired network in order to interface with the Internet, other carrier voice and data networks, business networks, and personal networks. A wired network is typically carried over copper twisted pair, coaxial cable and/or fiber optic cables. There are many different types of wired networks including wide area networks (WAN), metropolitan area networks (MAN), local area networks (LAN), Internet area networks (IAN), campus area networks (CAN), global area networks (GAN), like the Internet, and virtual private networks (VPN).

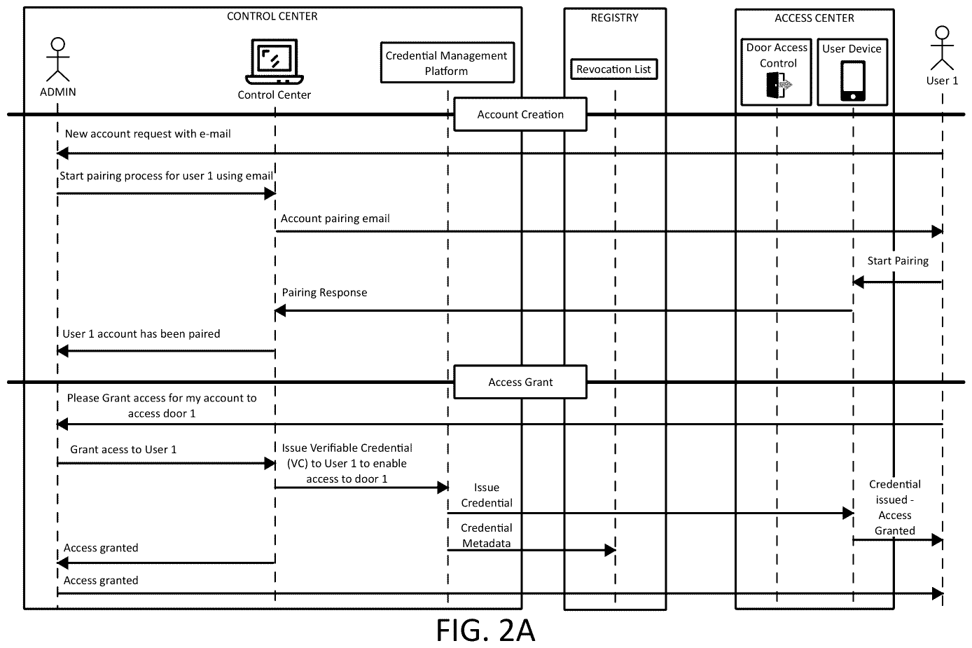

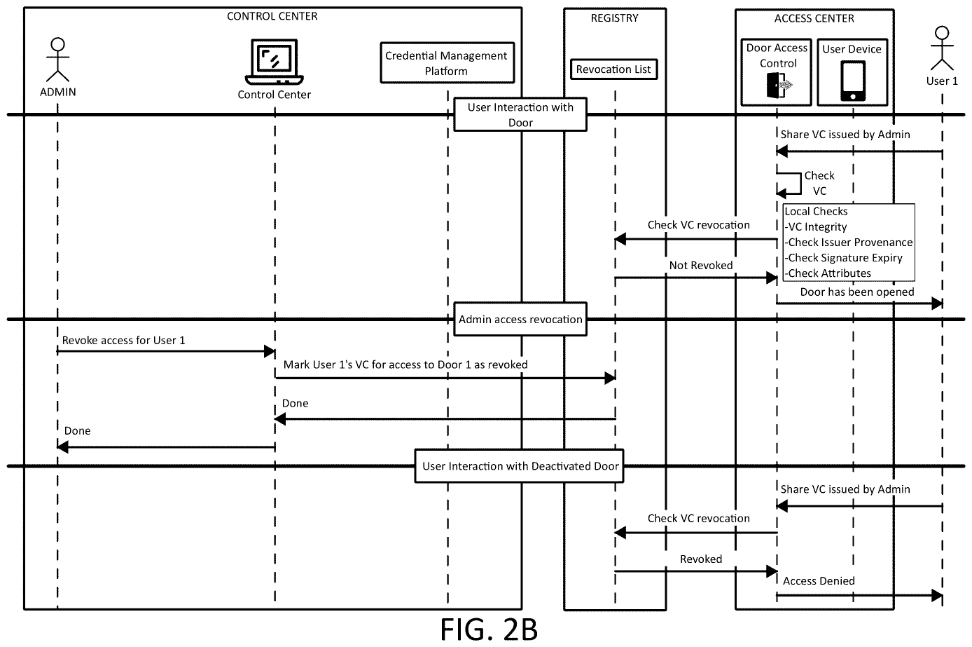

In some embodiments, instructions associated with the functions described herein may be stored in the memory and executed by the processor of one or more of the registry 110, control center 120, user device 130, and/or door access control 140. For example, the functions shown in FIGS. 2A and 2B (described herein) may be executed by software stored at a memory and executed at a processor of one of the respective registry 110, control center 120, user device 130, and/or door access control 140, as identified in FIGS. 2A and 2B.

The architecture of the system is defined by three primary personas or roles: the issuer, the user, and the resource. The issuer is the entity responsible for creating and distributing credentials, typically embodied by an Administrator or an Identity and Access Management (IAM) Control Center. This person or process controls access to the physical resources owned and operated by an organization. The user, who functions as both the holder of the verifiable credential and the subject of the assertions within it, represents any individual seeking access, such as employees, contractors, or visitors. Finally, the resources themselves act as the verifiers in the system. These are the physical assets to which access is controlled and can include a wide range of items such as brick-and-mortar building locations, special access rooms, storage containers or facilities, as well as mobile assets like fleet vehicles, drones, aircraft, and heavy equipment.

Administrators or admins can use identifiers and asymmetric cryptography keys. The identifiers may be distributed via trust systems. The asymmetric keys may be generated as key pairs using cryptography in a secure environment. The private key, which is used for signing assertions, is stored in a secure environment and is controlled by the Administrator. The public key from the key pair may be distributed using trust mechanisms. In some implementations, the public key(s) of the issuer(s) is distributed to the physical access control devices using secure communication channels.

In the context of issuing a verifiable credential (VC), as detailed in FIG. 2A, the issuer (e.g., the control center 120) utilizes its private key to generate the digital signature that is embedded within or attached to the VC. This cryptographic action ensures the authenticity and integrity of the credential, proving that it originated from the legitimate issuer and has not been altered.

The holders use a wireless enabled compute device (e.g., smart device, smart phone, tablet, smart watch, laptop computer, etc.), which, as noted above, includes at least a processor, a memory, and a wireless transceiver, and has an app installed. The app includes capabilities to create asymmetric keys, accept credentials from issuers, securely store issued credentials, and/or present credentials with consent to verifiers.

FIGS. 2A and 2B graphically depicts the functions, devices and communication signals described herein. FIG. 2B may be a continuation of FIG. 2A. The registry 110 functions as a repository for credential status and metadata. The registry 110 may be deployed within an organization's private network infrastructure, such that the communication link between the door access control 140 and the registry 110 is a local area network (LAN) or wireless local area network (WLAN). In such embodiments, a connection to the public internet is not required for the verifier to query the registry. Upon issuance of a verifiable credential, the control center 120 may transmit relevant metadata about the credential to the registry 110. The registry 110 maintains a revocation list, which is a real-time record of credentials that have been deactivated by an administrator. As shown in FIG. 2B, a verifier, such as a door access control 140, can query the registry 110 during an access attempt to confirm that a presented credential has not been revoked.

In some implementations, it is desired for verifiers to accept and store keys that clearly identify known issuers, accept VC presentations from holders, and control the access to the physical resource they control.

The system operates based on two fundamental cryptographic interactions, which are illustrated in the sequence diagrams of FIGS. 2A and 2B: a Wallet Pairing process to establish a trusted relationship, and a verifiable Presentation process to request access.

The application of this wallet pairing process within the broader account creation and access grant workflow is detailed in FIG. 2A. The wallet pairing is a prerequisite step performed before an issuer creates a verifiable credential for a holder. To establish a trusted relationship, the issuer initiates a challenge-response protocol by sending a unique, cryptographically random string (a nonce) to the holder's device via a secure channel such as an email, text message, or QR code. The holder's wallet application receives this challenge and constructs a signed response. This response payload confirms receipt of the original challenge, includes a timestamp to ensure the transaction is recent and prevent replay attacks, and provides an identifier for the holder so the issuer can retrieve their public key. The entire payload is digitally signed by the holder, cryptographically proving their control over the device and securely pairing the device to the issuer.

As shown in FIG. 2A, the method for account creation and the granting of access through the issuance of a certifiable credential. The process involves interactions between an admin, a control center (which includes a credential management platform), a registry, an access center (which includes a door access control device and a user device), and a user 1. The overall process may include parts: account creation and access grant.

The account creation phase begins when an admin initiates a new account request for user 1 via the control center. In response, the control center begins the wallet pairing process, which establishes a secure and trusted relationship with the user's device. As illustrated, after the request from user 1, the control center sends an “account pairing email” to user 1. The control Center and the user Device then complete the exchange with a “Pairing response.” This sequence represents the wallet pairing process described above, wherein a trusted cryptographic relationship is established, for example, through a challenge-response protocol. Upon successful completion, the Control Center internally notes that the “user 1 account has been paired.

The Access Grant phase is initiated once the user's account is paired. An Admin sends a request to the Control Center to grant user 1 access to a specific physical resource, in this case, “Door 1.” The Control Center processes this request, and its Credential Management Platform proceeds to “Issue verifiable credential (VC) to user 1.” This VC is a cryptographically signed digital asset containing the assertions necessary to enable access to Door 1. The VC is transmitted securely to the user Device of user 1. Upon receipt, the user Device stores the credential, and the user is notified that “Access granted”.

Simultaneous with or subsequent to the issuance of the credential, the Control Center's Credential Management Platform also transmits “Credential metadata” to the Registry. The Registry stores this information, including data that may be used for later status checks, such as populating the “Revocation List” as shown in FIG. 2B. This step ensures that the system has a record of the issued credential for management and potential revocation. Finally, the Control Center provides a confirmation to the admin that access has been granted, completing the access grant workflow. The credential metadata may include issuer ID, credential type, issuance data, expiration date, revocation mechanism, and schema.

verifiable presentation is the process used when a holder seeks access to a resource. The verifier (e.g., a smart lock) initiates the interaction, often by issuing its own challenge to the holder's device. In response, the holder's device compiles a verifiable presentation, which is a signed assertion made by the holder. This presentation contains the necessary verifiable credential(s) from one or more issuers, an identifier for the holder, and a timestamp. Most importantly, it includes what is referred to herein as a proof-of-possession signature. A proof-of-possession signature is a new, single-use signature generated by the holder's device for the specific transaction, which cryptographically proves the binding of the holder to the credential at that moment. This signature confirms to the verifier that the credential has not been stolen and that the presenter is in possession of the cryptographic material linked to it. To perform this local verification, the door access control device utilizes two distinct public keys that it has securely stored in its memory: the issuer's public key and the holder's public key. It first uses the issuer's public key to validate the digital signature on the VC, confirming the credential's authenticity. It then uses the holder's public key to validate the proof-of-possession signature, confirming the live presence of the legitimate holder. Before granting access, the verifier also performs a series of local checks on the credential itself, which can include verifying the VC's integrity, confirming the issuer's identity and trustworthiness (provenance), checking for the signature's expiration, and evaluating other business logic attributes such as time-based access rules, and/or specific door access. The presentation may also include the verifier's original challenge string, further securing the transaction against replay attacks and ensuring it is a direct response to a specific access request.

Given the constraints of the embedded systems that may be used in these physical spaces, example optimizations for increasing both the speed of the interactions and the overall user experience are described herein.

By using selective disclosure, the user's device can hold and/or store a large number of credentials for various resources, but still present a relatively small VC proof at the time of access to a particular resource. For example, a typical Bluetooth Low-Energy (BLE) Maximum Transmission Unit is 20 bytes by default, or up to 512 bytes on modern hardware. Sending more data than that would incur large wait times for the user. By disclosing a reduced (e.g., minimum) amount of information per request, this may be significantly reduced. For example, a door may constantly broadcast its UUID so the phone will only selectively disclose that it has access to that door and no more. Thus, keeping the amount of information disclosed and data transmitted to a minimum.

The system supports multiple embodiments for managing credential revocation, ensuring security in both connected and standalone operational modes. In a standalone or disconnected mode, the system enables a secure offline access-control system by requiring the user's device to present two distinct cryptographic proofs within its Verifiable Presentation (VP). The first proof is the primary Verifiable Credential (VC) and the corresponding proof-of-possession signature, which proves the Holder's identity and binding to the credential. The second proof is a separate, short-lived credential, herein referred to as a ‘status credential,’ which serves as a proof of non-revocation.

The status credential is a digitally signed assertion from the issuer or registry, obtained periodically by the user's device when it has network connectivity. This status credential attests that the primary VC was still valid as of a specific issuance time and is set to expire after a predetermined interval (e.g., 24 hours). An offline door access control device is configured to verify both proofs. It first validates the primary VC and the proof-of-possession signature. It then validates the issuer's signature on the status credential and checks its timestamp to ensure it is within the valid time threshold. Access is granted only if all verifications succeed. This mechanism is particularly useful for resources far from infrastructure, such as in a remote factory or on a vehicle.

In a connected or networked embodiment, as illustrated in FIG. 2B, the door access control 140 may alternatively perform a direct check by communicating with the registry 110 to query the status of the presented VC's unique identifier. An administrator can revoke access by instructing the control center 120 to update the revocation list within the registry 110, ensuring that any subsequent verification attempts for that VC will fail.

The term issuer provenance refers to the authenticity and integrity of the verifiable credential (VC) itself. Provenance validates the authenticity of the credential and is established at the time of issuance when the issuer (e.g., the control center 120) applies its digital signature, generated with its private key, to the VC. Verification of provenance, therefore, involves the verifier (e.g., the door access control device 140) using the issuer's public key to validate this signature, thereby confirming that the credential is an unaltered artifact originating from a trusted source.

The proof-of-possession signature is a dynamic, transactional element that pertains to the holder of the credential at the moment of an access request. Proof-of-possession signature validates the legitimacy of the presenter and it is a new digital signature generated by the user device 130, using the holder's private key, on the verifiable presentation (VP). Verification of the proof-of-possession signature involves the verifier using the holder's public key to validate this live signature. This confirms that the entity presenting the credential is in active possession and control of the private key associated with the credential, thus preventing the use of stolen or copied credential data and mitigating replay attacks.

Short-range wireless radios may be limited to a relatively small number of connections per device. Thus, by using signal strength and other distance bounding metrics, along with identifiable information of the resource, the user's device can limit its connections to those devices that the user's device actually has access to and are nearby (and not other devices). By maintaining the connection after the initial access, experiences like holding the resource unlocked while the user is in proximity may be enabled. Moreover, by maintaining a connection, Access-Control-initiated actions are also enabled, as the access control system can issue an unauthenticated prompt or request informing the user device to present a VC to approve the action.

The acts performed as part of a disclosed method(s) may be ordered in any suitable way. Accordingly, embodiments may be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also may be referred to as a non-transitory processor-readable medium and/or a machine-readable medium) having instructions or computer code thereon for performing various computer-implemented operations. The computer-readable medium (or processor-readable medium, machine-readable medium, etc.) is non-transitory in the sense that it does not include transitory propagating signals per se (e.g., a propagating electromagnetic wave carrying information on a transmission medium such as space or a cable). The media and computer code (also may be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein may be performed by software (executed on hardware), hardware, or a combination thereof. Hardware modules can include, for example, a processor, a field programmable gate array (FPGA), and/or an application specific integrated circuit (ASIC). Software modules (executed on hardware) can include instructions stored in a memory that is operably coupled to a processor and may be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The foregoing examples have been provided merely for the purpose of explanation and are in no way to be construed as limiting of implementations of the present invention. While aspects of the present invention have been described with reference to an exemplary embodiment, the words which have been used herein are words of description and illustration, rather than words of limitation. Changes may be made, within the purview of the appended claims, as presently stated and as amended, without departing from the scope and spirit of the present disclosure in its aspects. Although implementations of the present invention have been described herein with reference to particular means, materials and embodiments, implementations disclosed herein are not intended to be limited to the particulars disclosed herein; rather, implementations of the present invention extend to all functionally equivalent structures, methods and uses, such as are within the scope of the appended claims.

What is claimed is:

1. A physical access control system, comprising:
a user device having a first processor, a first memory, and a first wireless transceiver, the first memory storing a verifiable credential (VC), wherein the VC is digitally signed by an issuer from a control center and contains one or more assertions related to physical access;
a door access control device having a second processor, a second memory, a second wireless transceiver, and an electronically controlled lock mechanism;
wherein the first processor of the user device is configured to:
generate a verifiable presentation (VP) comprising the VC and a proof-of-possession signature, the proof-of-possession signature being generated by the user device in response to an access request; and
transmit the VP via the first wireless transceiver
wherein the second processor of the door access control device is configured to:
receive the VP from the user device via the second wireless transceiver;
locally verify both the issuer's digital signature on the VC and the user device's proof-of-possession signature on the VP, wherein the local verification is executed, outside of the control center, using data stored in the second memory and data received in the VP; and
actuate the electronically controlled lock mechanism to grant access based on a successful local verification of both signatures.

2. The system of claim 1, wherein the door access control device is further configured to transmit a challenge string to the user device, and wherein the user device is configured to include the challenge string in the generation of the proof-of-possession signature.

3. The system of claim 1, wherein the local verification performed by the second processor further comprises verifying at least one business logic attribute contained within the one or more assertions of the VC, the at least one business logic attribute selected from a group consisting of a time-based access rule, an issuer provenance, and a specific resource identifier.

4. The system of claim 1, further comprising a registry communicably coupled to the door access control device via a network, the registry configured to store a revocation list, and wherein the second processor is further configured to query the registry to confirm the VC is not on the revocation list as part of the verification.

5. The system of claim 1, wherein the VP further comprises a proof of non-revocation, and wherein the local verification performed by the second processor further comprises verifying the proof of non-revocation to confirm the VC has not been revoked, enabling secure verification in an offline mode where the door access control device is disconnected from any network.

6. The system of claim 1, wherein the user device is paired with the issuer via a cryptographic challenge-response protocol prior to the issuer provisioning the VC to the user device.

7. The system of claim 1, wherein the user device is configured selectively disclose VP to minimize data transmission over a low-energy wireless protocol.

8. A method for decentralized physical access control, the method comprising the steps of:
receiving, by a processor of a door access control device from a user device, a verifiable presentation (VP), the VP comprising:
a verifiable credential (VC) digitally signed by an issuer from a control center and containing one or more assertions;
a proof-of-possession signature generated by the user device;
locally verifying outside of the control center, by the processor of the door access control device, the integrity and authenticity of the VP, wherein locally verifying includes:
validating the issuer's digital signature on the VC; and
validating the user device's proof-of-possession signature on the VP; and
actuating, by the door access control device, a physical lock mechanism to an unlocked state in response to the successful validation of both the issuer's digital signature and the proof-of-possession signature.

9. The method of claim 8, further comprising the following steps:
prior to receiving the VP, transmitting, by the door access control device, a cryptographically random challenge string to the user device; and
wherein validating the proof-of-possession signature comprises confirming the signature was generated using the challenge string.

10. The method of claim 8, wherein locally verifying further comprises validating a proof of non-revocation included in the VP, thereby confirming the VC's validity while the door access control device is operating in a disconnected state.

11. The method of claim 8, further comprising:
prior to actuating the physical lock mechanism, querying, by the door access control device, a remote registry over a local network to determine if the VC is present on a revocation list.

12. The method of claim 8, further comprising establishing, prior to the issuance of the VC, a trusted pairing between the user device and the issuer by executing a challenge-response protocol.

13. The method of claim 8, wherein the VP is received over a Bluetooth Low-Energy (BLE) connection and contains only a subset of assertions from the VC necessary for the access request.

14. A door access control device for a decentralized physical access control system, comprising:
a processor;
a wireless transceiver;
an electronically controlled lock mechanism; and
a memory storing instructions that, when executed by the processor, cause the door access control device to:
receive, via the wireless transceiver from a user device, a verifiable presentation (VP), the VP including a verifiable credential (VC) signed by an issuer from a control center and a proof-of-possession signature generated by the user device;
locally verify, without communication to the control center, both the issuer's digital signature on the VC and the user device's proof-of-possession signature on the VP; and
actuate the electronically controlled lock mechanism to grant access based on a successful local verification of both signatures.

15. The door access control device of claim 14, wherein the instructions further cause the processor to transmit a challenge string to the user device via the wireless transceiver prior to receiving the VP.

16. The door access control device of claim 14, wherein the instructions further cause the processor to verify a proof of non-revocation contained within the VP, thereby enabling secure operation in an offline mode.

17. The door access control device of claim 14, wherein the instructions further cause the processor to query a revocation list stored on a registry via a network connection to confirm the VC has not been revoked.

18. The door access control device of claim 14, wherein the local verification performed by the processor further comprises verifying at least one business logic attribute contained within the one or more assertions of the VC, the at least one business logic attribute selected from a group consisting of a time-based access rule, an issuer provenance, and a specific resource identifier.

19. The door access control device of claim 14, wherein the instructions further cause the processor to:
maintain a connection with the user device via the wireless transceiver subsequent to the successful local verification; and
maintain the electronically controlled lock mechanism in an unlocked state based on a proximity of the user device, the proximity determined using signal strength metrics from the maintained connection.
